(19) United States
(12) Patent Application Publication
(10) Pub. No.: US 2008/0225214 A1
(43) Pub. Date: Sep. 18, 2008

(54) Liquid Crystal Display Apparatus and Fabrication Method for Liquid Crystal Display Apparatus

(76) Inventors: Tomoatsu Kinoshita, Tokyo (JP); Akihiko Asano, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/597,257

(22) PCT Filed: Jan. 21, 2005
(86) PCT No.: PCT/JP2005/001165

§ 371 Date: Jul. 18, 2006

(30) Foreign Application Priority Data
Jan. 21, 2004 (JP) 2004-012612

(51) Int. Cl. G02F 1/1333

(52) U.S. Cl. 349/122

(57) ABSTRACT

A difference in brightness between a portion, at which fiber overlaps, and any other portion of a plastic substrate in which a fiber cloth is contained is eliminated by setting the axis of the fiber and the optical axis of a polarizing plate so as to be coaxial with each other. Thereby, a normal displaying can be effected. In a liquid crystal display apparatus wherein a liquid crystal driving electrode (not shown) is formed on at least one of an active substrate 11 and an opposing substrate 12 in pair opposing to each other and liquid crystal (liquid crystal layer 13) is encapsulated in a space formed between the substrates, at least one of the pair of substrates, for example, the active substrate 11, is a resin substrate which contains a fiber cloth 16, and, first, second polarizing plates 14, 15 are provided on the outer side of at least one of the pair of substrates, for example, on the opposite sides, and besides an axis of the fiber cloth 16 and an optical axis of the first polarizing plate 14 are coaxial with each other.

### TECHNICAL FIELD

The present invention relates to a liquid crystal display apparatus for which a resin substrate is used and a fabrication method for a liquid crystal display apparatus.

### BACKGROUND ART

In recent years, it is demanded for a thin film device to have a reduced thickness and weight and an increased durability under the influence of downsizing of used equipments. However, since a thin film device used in a liquid crystal display device is produced in an environment of a high temperature and vacuum, there is a limitation to a substrate used for fabrication of the thin film device. For example, a quartz substrate which withstands a temperature of 1000° C. and a glass substrate which withstands another temperature of 500° C. are used for a liquid crystal display apparatus in which a thin film transistor is used. While also reduction in thickness of the substrates is examined, as far as a quartz substrate or a glass substrate is used, it cannot be avoided to reduce the substrate size taking it into consideration that the rigidity of the substrate decreases. Such reduction of the substrate size decreases the productivity. Further, if the thickness of the substrate decreases, also the durability decreases suddenly, and this makes a problem in practical use.

In this manner, performances required for a substrate for fabrication and performances required in actual use are different from each other. Also it is attempted to produce a thin film transistor directly on a plastic substrate which has a reduced thickness and weight and an increased durability. In this instance, while a passive type liquid crystal display apparatus in which an active device is not used is mass produced in the form of an apparatus of a monochrome type, an active type liquid crystal display apparatus in which a thin film transistor or a thin film diode is used is higher in difficulty from a point of view of the heatproof temperature of the substrate.

Therefore, a technique for transferring a thin film device formed on a substrate for fabrication having a high heatproof temperature to an actually used substrate is examined. As a transferring method, a method wherein a peeling layer is formed and a thin film device is peeled from the peeling layer after the device is produced (for example, refer to Japanese Patent Laid-open No. Hei 10-125930), another method wherein a glass substrate is removed by etching (for example, refer to Japanese Patent Laid-open No. 2003-68995) and so forth are examined. A thin film device can be formed on a plastic substrate using the methods just mentioned.

However, if a thin film device layer is formed on a normal plastic substrate having a high expansion coefficient, then this gives rise to a problem that, if heat is applied to the thin film device layer after formed, then the thin film device layer warped because the expansion coefficients of the thin film device layer formed mainly from an inorganic layer and the plastic substrate are different from each other. Further, if the temperature rises still higher in the state wherein the thin film device layer warps, then a crack may possibly appear on the thin film layer, resulting in breakdown of the thin film layer. Therefore, in order to form a thin film device layer on a plastic substrate, a plastic substrate having a low expansion coefficient must be used.

However, there is a problem that a plastic substrate having a low expansion coefficient is very expansive or a plastic substrate is sometimes in a colored state like a polyimide substrate and cannot be used for a transmission type liquid crystal display apparatus.

As shown in a top plan layout view of FIG. 14A and a perspective view of FIG. 14B, a plastic substrate is known wherein a fiber cloth 502 is contained in a plastic substrate 501 which has a lower expansion coefficient (for example, refer to Japanese Patent Laid-open No. Hei 11-2812, Japanese Patent Laid-open No. 2003-202816). As the fiber cloth 502, a glass cloth, a polyimide cloth, a metal cloth or the like is used, and above all, a glass cloth is used most popularly. Where a glass cloth and transparent resin are used, a transparent plastic substrate can be produced, and the plastic substrate can be used also in a transmission type liquid crystal display apparatus. The plastic substrate 501 which contains a glass cloth is produced by containing a glass cloth in resin in the form of liquid and hardening the resin by heating, light irradiation or vaporization of the solvent. As the glass cloth, in order to adjust the linear expansion coefficients in the crosswise directions, a glass cloth plain-weaved in a check pattern is commonly used as shown in FIG. 14A because the strength is high and the cost is low. In this instance, the resin exists between a yarn (fiber bundle) 503 and an adjacent yarn (fiber bundle) 503, and portions only of the resin and portions at which the fiber cloth 502 is included exist. The linear expansion coefficient of the plastic substrate 501 produced in such a manner as described above can be suppressed to 15 ppm/K or less in an in-plane direction.

### DISCLOSURE OF INVENTION

The problem to be solved is that, where a plastic substrate which contains glass fiber is used, there is a problem that, when resin which forms the plastic substrate hardens, stress is applied, as seen in FIG. 15, to the resin at an overlapping portion of the glass fiber (portion indicated by a round mark in FIG. 15) and the resin at the portion has double refraction. An outline of transmission of light, for example, through a liquid crystal display apparatus in which a plastic substrate which contains glass fiber is used is described with reference to FIGS. 16 to 17. In FIGS. 16 to 17, a state is shown wherein a voltage is applied to TN liquid crystal in a normally white mode to display the black.

FIG. 16 shows a light transmission state of a region which is not an overlapping portion of glass fiber within a region of a plastic substrate which contains glass fiber. Since this region does not have double refraction, light emitted from a backlight is converted into linearly polarized light by a first polarizing plate 560 and passes as it is through an active substrate 510, a liquid crystal layer 520 and an opposing substrate 530 until it comes to a second polarizing plate 570. Then, the light is blocked completely by the second polarizing plate 570 and does not pass through the second polarizing plate 570.

FIG. 17 shows another light transmission state where the optical axis of double refraction and the axis of polarizing plates are not coaxial at an overlapping portion of glass fiber. In this instance, light emitted from a backlight is converted into linearly polarized light by a first polarizing plate 560, and the linearly polarized light is converted into elliptically polarized light by an active substrate 510, a liquid crystal layer 520 and an opposing substrate 530 which have double refraction. Therefore, the light passes from the first polarizing plate 560 to the second polarizing plate 570. This gives rise to a problem that the brightness is different between the portion at which the glass fiber overlaps and any other portion. Further, also in regard to any other gradation than the black, the problem that the brightness is different between the portion at which the glass fiber overlaps and any other portion occurs. Therefore, normal display as a liquid crystal display apparatus cannot be achieved.

According to the present invention, a liquid crystal display apparatus wherein a liquid crystal driving electrode is formed on at least one of a pair of substrates opposing to each other and liquid crystal is encapsulated in a space formed with a distance between the substrates which is kept by a spacer provided between the substrates, is characterized in that at least one of the pair of substrates is a resin substrate which contains a fiber cloth, that a polarizing plate is provided on the outer side of at least one of the pair of substrates, and that an axis of the fiber and an optical axis of the polarizing plate are coaxial with each other.

According to the present invention, a fabrication method for a liquid crystal display apparatus wherein a liquid crystal driving electrode is formed on at least one of a pair of substrates opposing to each other and liquid crystal is encapsulated in a space formed with a distance between the substrates which is kept by a spacer provided between the substrates, is characterized in that a resin substrate which contains a fiber cloth for at least one of the pair of substrates, that a polarizing plate is disposed on the outer side of at least one of the pair of substrates, and an axis of the fiber and an optical axis of the polarizing plate are made coaxial with each other.

### BRIEF DESCRIPTION OF DRAWINGS

FIG. 1 is a schematic configuration sectional view showing an embodiment of a liquid crystal display apparatus and a fabrication method for a liquid crystal display apparatus.

FIG. 2 is an explanatory view showing an outline of light transmission of the liquid crystal display apparatus of the present invention.

FIG. 3 is a sectional view showing a first example of the liquid crystal display apparatus and fabrication method for a liquid crystal display apparatus of the present invention.

FIGS. 4A and 4B are sectional views showing the first example of the liquid crystal display apparatus and the fabrication method for a liquid crystal display apparatus of the present invention.

FIGS. 5A, 5B and 5C are sectional views showing the first example of the liquid crystal display apparatus and the fabrication method for a liquid crystal display apparatus of the present invention.

FIG. 6 is a sectional view showing the first example of the liquid crystal display apparatus and the fabrication method for a liquid crystal display apparatus of the present invention.

FIG. 7 is a sectional view showing the first example of the liquid crystal display apparatus and the fabrication method for a liquid crystal display apparatus of the present invention.

FIG. 8 is an explanatory view showing an outline of light transmission of the liquid crystal display apparatus of the first example of the present invention.

FIG. 9 is a sectional view showing a second example of the liquid crystal display apparatus and the fabrication method for a liquid crystal display apparatus of the present invention.

FIGS. 10A, 10B and 10C are sectional views showing the second example of the liquid crystal display apparatus and the fabrication method for a liquid crystal display apparatus of the present invention.

FIG. 11 is a sectional view showing the second example of the liquid crystal display apparatus and the fabrication method for a liquid crystal display apparatus of the present invention.

FIGS. 12A and 12B are sectional views showing a third example of the liquid crystal display apparatus and the fabrication method for a liquid crystal display apparatus of the present invention.

FIGS. 13A, 13B and 13C are sectional views showing the third example of the liquid crystal display apparatus and the fabrication method for a liquid crystal display apparatus of the present invention.

FIGS. 14A and 14B are explanatory views of a plastic substrate used in a conventional transmission type liquid crystal display apparatus.

FIG. 15 is an explanatory view of a fiber cloth in a plastic substrate.

FIG. 16 is an explanatory view showing an outline of light transmission through the conventional liquid crystal display apparatus.

FIG. 17 is an explanatory view showing an outline of light transmission through the conventional liquid crystal display apparatus.

### BEST MODE FOR CARRYING OUT THE INVENTION

An object of eliminating an influence of double refraction which resin, which forms a plastic substrate, has at an overlapping portion of glass fiber where the glass fiber is contained in the plastic substrate when stress is applied to the resin at the overlapping portion of the glass fiber is achieved by a liquid crystal display apparatus wherein a liquid crystal driving electrode is formed on at least one of a pair of substrates opposing to each other and liquid crystal is encapsulated in a space formed with a distance between the substrates which is kept by a spacer provided between the substrates, characterized in that at least one of the pair of substrates is a resin substrate which contains a fiber cloth, that a polarizing plate is provided on the outer side of at least one of the pair of substrates, and that an axis of the fiber and an optical axis of the polarizing plate are coaxial with each other, whereby, at the overlapping portion of the glass fiber, normal display similar to that at any other portion can be obtained.

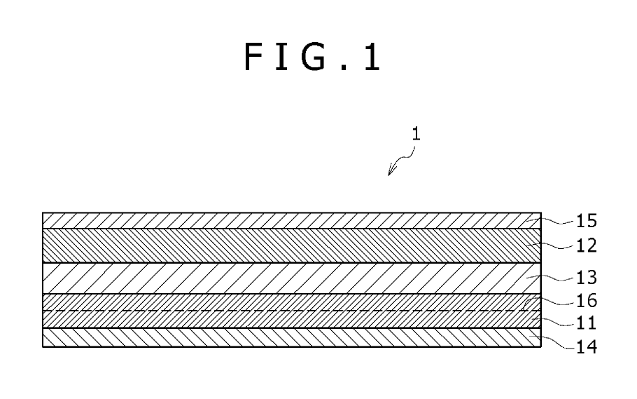

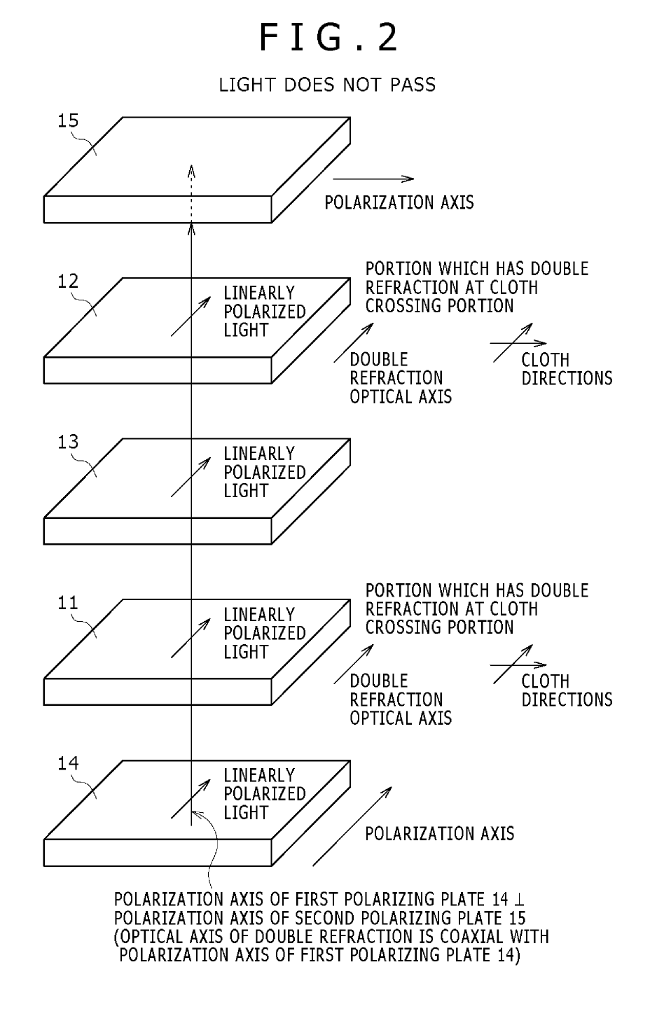

Now, an embodiment of a liquid crystal display apparatus and a fabrication method for a liquid crystal display apparatus of the present invention is described particularly with reference to a schematic sectional view of FIG. 1 and a schematic configuration view of FIG. 2. In FIG. 2, a state is shown wherein a voltage is applied to TN liquid crystal to display black in a normally white mode.

As shown in FIG. 1, a liquid crystal display apparatus 1 is configured such that a pair of substrates opposing to each other, that is, an active substrate 11 and an opposing substrate 12, are provided in an opposing relationship to each other and a liquid crystal driving electrode (not shown) is formed on at least one of the paired substrates and a liquid crystal layer 13 is encapsulated in a space formed with a distance between the substrates by a spacer (not shown) provided between the substrates. A resin substrate which contains a fiber cloth is used for at least one of the paired substrates. In the configuration shown in FIG. 1, a fiber cloth 16 is contained in the active substrate 11 as an example. The fiber cloth 16 has a structure plain-weaved in a check pattern and includes, in a principal face of the active substrate 11, a region in which only the resin which forms the active substrate 11 exists and regions in which the resin and the fiber cloth 16 exist as viewed in the thicknesswise direction of the active substrate 11. For example, as the fiber cloth 16, a glass cloth, a polyimide cloth, a metal cloth or the like is used. More preferably, a glass cloth is used. Further, though not shown, also a resin substrate in which a fiber cloth is contained can be used for the opposing substrate 12. Further, a polarizing plate is provided on the outer side of at least one of the paired substrates. In FIG. 1, a first polarizing plate 14 is provided on the outer side of the active substrate 11 and a second polarizing plate 15 is provided on the outer side of the opposing substrate 12, and besides the axis of the fiber (in other words, the optical axis of double refraction) and the polarization axis of the first polarizing plate 14 are arranged in a coaxial direction.

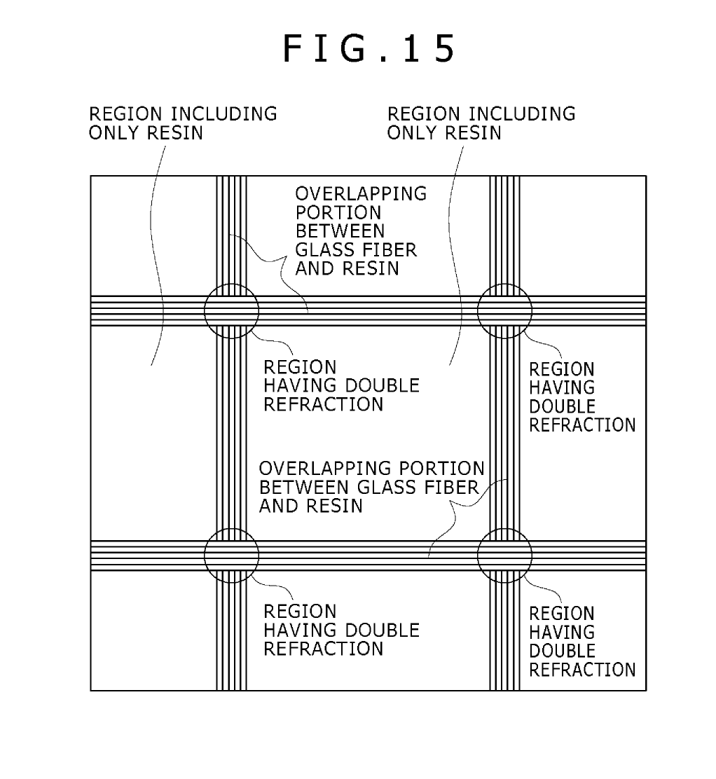

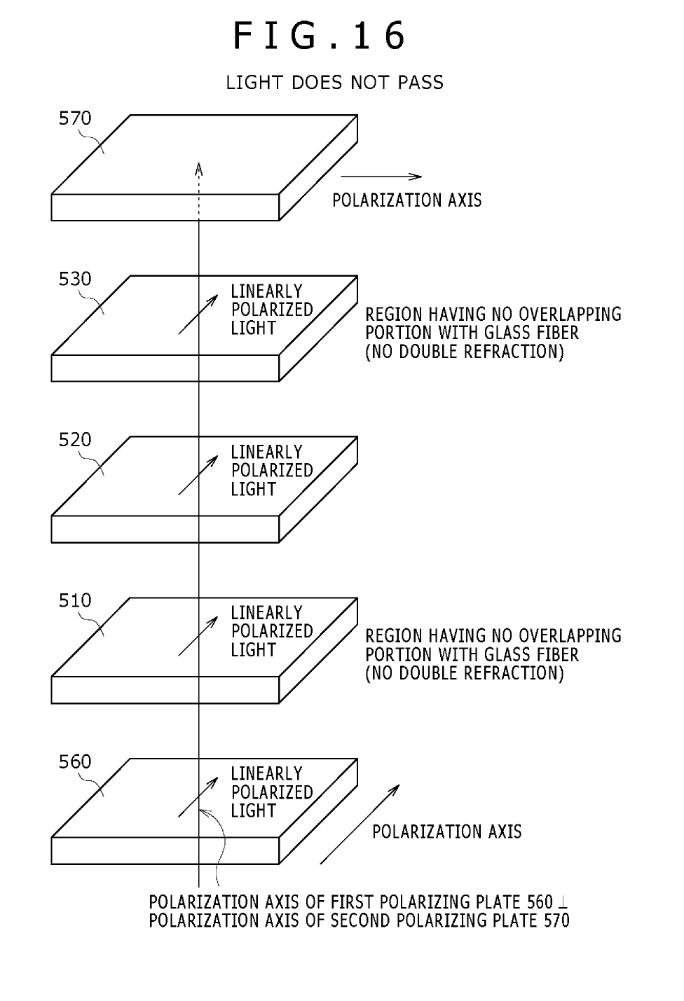

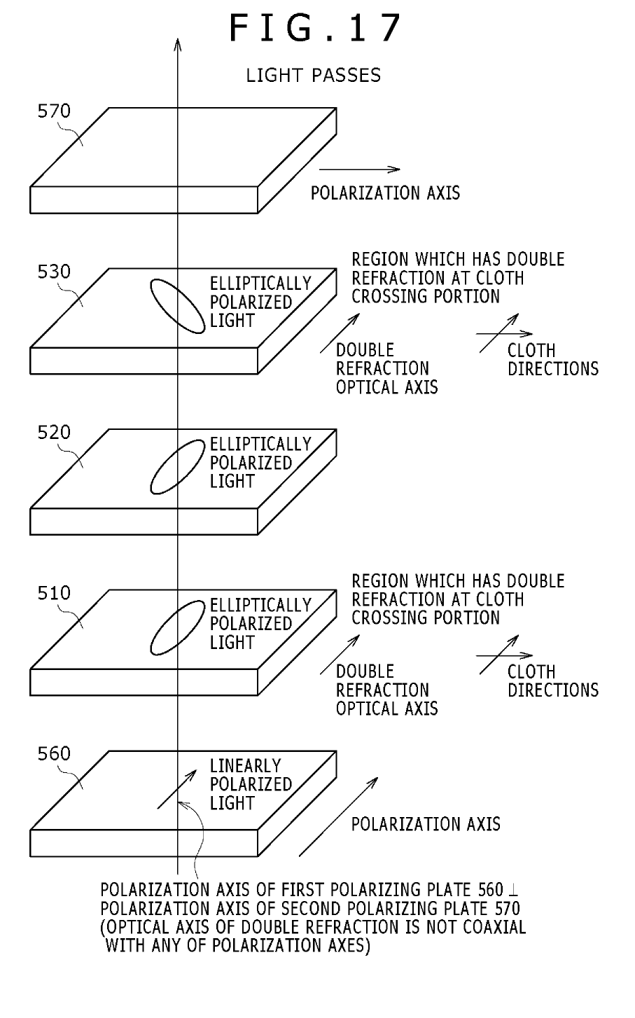

An outline of light transmission through the liquid crystal display apparatus is described with reference to FIG. 2. As shown in FIG. 2, where the optical axis of double refraction and the axis of the first polarizing plate 14 are coaxial with each other, linearly polarized light having passed through the first polarizing plate 14 does not change to elliptically polarized light also in the active substrate 11 which has double refraction but passes through the active substrate 11 while it remains as it is. Therefore, the light cannot pass through the second polarizing plate 15, and the liquid crystal display apparatus performs displaying operation similar to that described hereinabove with reference to FIG. 15. In particular, since any region in which the glass fiber does not overlap within the region of the plastic substrate which contains the glass fiber does not have double refraction, light outputted from a backlight is converted into linearly polarized light by the first polarizing plate 14 and comes as it is to the second polarizing plate 15. Then, the light is blocked completely by the second polarizing plate 15 and does not pass through the second polarizing plate 15. Also in regard to any other gradation than the black, similarly any overlapping portion of the glass fiber and any other portion can perform the same displaying operation, and normal display as a liquid crystal display apparatus can be achieved.

### EXAMPLE 1

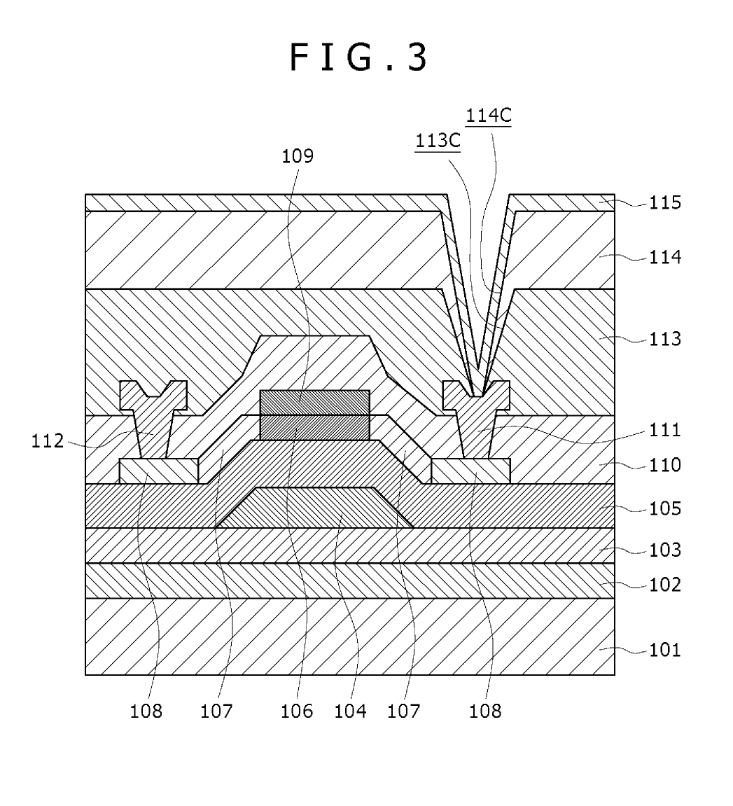

A first example of the liquid crystal display apparatus and the fabrication method for a liquid crystal display apparatus of the present invention is described with reference to FIGS. 3 to 8. In the present example, an active substrate for transmission type liquid crystal was produced as a plastic substrate.

First, a forming method for a thin film device layer is described with reference to FIG. 3. As shown in FIG. 3, a protective layer 102 for a first substrate 101 upon etching performed later using hydrofluoric acid is formed on the first substrate 101. A glass substrate having a thickness of, for example, approximately 0.4 mm to 1.1 mm, a thickness of for example, 0.7 mm, is used as the first substrate 101. A quartz substrate may be used in place of the glass substrate. The protective layer 102 is formed using a material which can withstand hydrofluoric acid, and was formed into a thickness of, for example, 500 nm using, for example, a molybdenum (Mo) layer. In this formation, the thickness of the molybdenum layer was 500 nm. However, as far as the molybdenum layer can withstand hydrofluoric acid, there is no problem even if the thickness thereof is suitably changed. The protective layer 102 of molybdenum can be formed, for example, by a sputtering method. Thereafter, an insulation layer 103 is formed. The insulation layer 103 is formed by forming, for example, a silicon dioxide (SiO₂) film into the thickness of 500 nm. The insulation layer 103 can be formed, for example, by a plasma CVD method.

Then, a common low-temperature poly-silicon technique, for example, such a low temperature poly-silicon bottom gate type thin film transistor (a thin film transistor is hereinafter referred to as TFT) process as disclosed, for example, in “2003 FPD technology complete collection” (Electronic Journal, issued Mar. 25, 2003, pp. 166 to 183 and pp. 198 to 201), “'99 latest liquid crystal process technique” (Press Journal, issued 1998, pp. 53 to 59), “Flat panel display 1999” (Nikkei BP Company, issued 1998, pp. 132 to 139) and so forth was used to form a thin film device layer including a TFT. An example of the forming method of a thin film device layer is described below.

First, a conductive film for forming the gate electrode 104 was formed on the insulation layer 103 formed on the first substrate 101 with the protective layer 102 interposed therebetween. A molybdenum (Mo) film of a thickness of, for example, 100 nm was used for the conductive film. For example, a sputtering method was used as a forming method of the molybdenum film. Then, the conductive film was formed into the gate electrode 104. The gate electrode 104 was formed by patterning using a common photolithography technique and etching technique. Then, the gate insulation film 105 was formed so as to coat the gate electrode 104. The gate insulation film 105 was formed from a silicon dioxide (SiO₂) layer, or a laminate of a silicon dioxide (SiO₂) layer and a silicon nitride (SiNₓ) layer, for example, by a plasma CVD method. Further, an amorphous silicon layer (thickness of 30 nm to 100 nm) was formed continuously.

XeCl excimer laser pulses of a wavelength of 308 nm ware irradiated upon the amorphous silicon layer so as to be melted and recrystallized to produce a crystal silicon layer (poly-silicon layer). The poly-silicon layer was used to form a poly-silicon layer 106 to make a channel forming region, and a poly-silicon layer 107 formed from an n− type doped region and a poly-silicon layer 108 formed from an n+ type doped region were formed on the opposite sides of the poly-silicon layer 106. In this manner, the active region was formed so as to have an LDD (Lightly Doped Drain) structure for achieving both of high on-current and low off-current. Further, a stopper layer 109 for protecting a channel upon implantation of n− type phosphorus ions was formed on the poly-silicon layer 106. The stopper layer 109 was formed, for example, from a silicon dioxide (SiO₂) layer.

Further, a passivation film 110 formed from a silicon dioxide (SiO₂) layer or a laminate of a silicon dioxide (SiO₂) layer and a silicon nitride (SiNₓ) layer was formed by a plasma CVD method. A source electrode 111 and a drain electrode 112 connected to the poly-silicon layers 108 were formed on the passivation film 110. The source electrode 111 and the drain electrode 112 were formed, for example, from a conductive material such as, for example, aluminum, aluminum alloy, high melting point metal or the like.

After the source electrode 111 and the drain electrode 112 were formed, a color filter 113 was formed. The color filter 113 was formed by coating color resist to the entire face and performing patterning by a lithography technique. A contact hole 113C was formed in the color filter 113 so that the source electrode 111 and a liquid crystal driving electrode to be formed later might be connected to each other. The forming step of a color filter was performed by three times to form color filters of the three colors of RGB (red, blue, green). Then, a protective film 114 was formed in order to perform flatting. The protective film 114 was formed, for example, from a resin of a polymethyl methacrylate resin type. Further, a contact hole 114C was formed in the protective film 114 so as to allow the source electrode 111 and the liquid crystal driving electrode to be connected to each other. Thereafter, a pixel electrode 115 was formed such that it was connected to the source electrode 111. The pixel electrode 115 is formed, for example, from a transparent electrode. The transparent electrode is formed, for example, from indium tin oxide (ITO), and a sputtering method is used as the forming method for the transparent electrode.

Through the steps described above, an active matrix substrate of the transmission type was successfully produced on the first substrate 101. Further, although, in the production described, a bottom gate type poly-silicon TFT was produced, the present invention can be carried out similarly also as a top gate type poly-silicon TFT or an amorphous TFT.

Now, a process of transferring a thin film device layer 121 on the first substrate 101 to a plastic substrate is described.

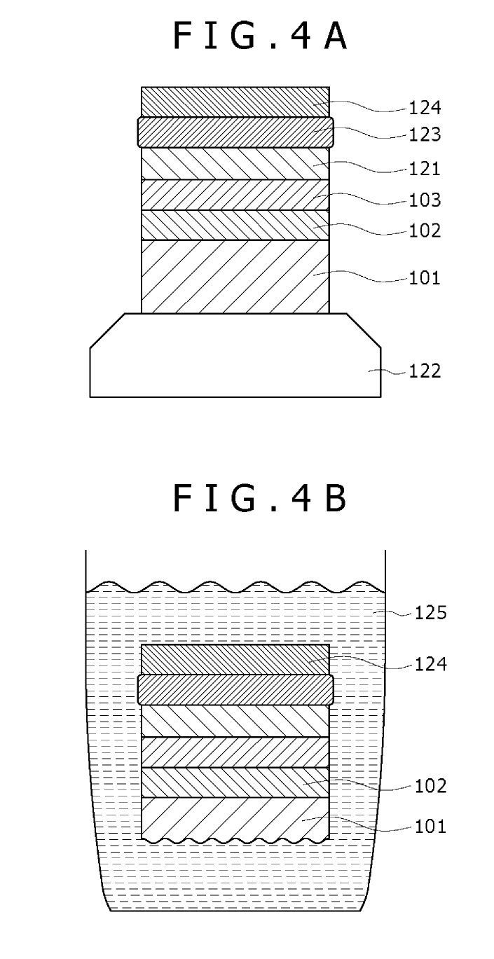

As shown in FIG. 4A, while a block wherein the protective layer 102, insulation layer 103 and thin film device layer 121 were formed on the first substrate 101 was heated to 80° C. to 140° C. by a hot plate 122, a first adhesive layer 123 is coated to a thickness of approximately 1 mm. Then, a second substrate 124 was placed on the first adhesive layer 123, and while the block was pressurized, it was cooled to room temperature. For example, a molybdenum substrate of a thickness of, for example, 1 mm was used for the second substrate 124. Alternatively, a glass substrate may be used for the second substrate 124. Further alternatively, the first adhesive layer 123 may be coated to the second substrate 124 and the thin film device layer 121 side portion of the first substrate 101 having the layers from the protective layer 102 to the thin film device layer 121 formed thereon may be placed on the first adhesive layer 123. For example, a hot melt bonding agent was used for the first adhesive layer 123.

Then, the first substrate 101 having the second substrate 124 pasted thereto was immersed in hydrofluoric acid (HF) 125 as shown in FIG. 4B to perform etching of the first substrate 101. This etching automatically stops at the protective layer 102 because the aluminum oxide layer as the protective layer 102 is not etched with the hydrofluoric acid 125. The hydrofluoric acid 125 used here had, as an example, a concentration by weight of 50%, and the etching time was 3.5 hours. There is no problem even if the concentration and the etching time of the hydrofluoric acid 125 are changed if it is possible to fully etch the glass of the first substrate 101.

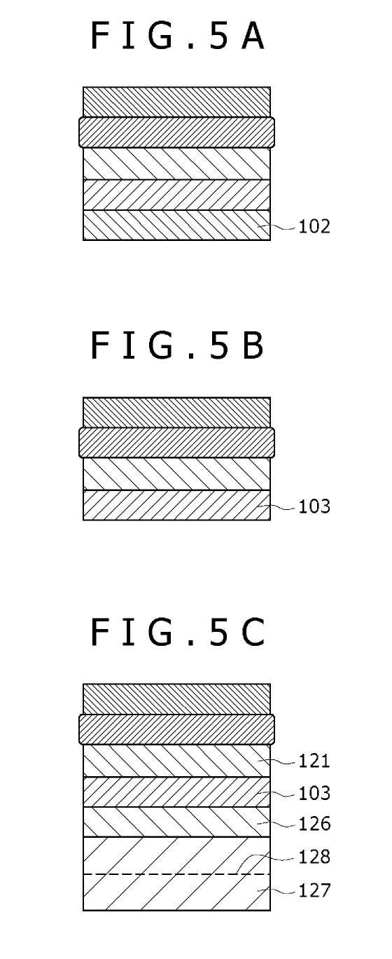

As a result of the etching with the hydrofluoric acid 125 described above, the first substrate 101 (refer to FIG. 4B) is etched fully until the protective layer 102 is exposed as seen in FIG. 5A.

Thereafter, mixed acid (for example, phosphoric acid (H₃PO₄) 72% by weight, nitric acid (HNO₃) 3% by weight and acetic acid (CH₃COOH) 10% by weight) was used to etch the molybdenum layer (thickness: 500 nm) as the protective layer 102 (refer to FIG. 5A). This is because, in order to produce a liquid crystal panel of the transmission type, if an opaque molybdenum layer is present, this makes a problem. The time required to etch a molybdenum layer of a thickness of 500 nm using the mixed acid mentioned above is approximately one minute. As a result of the etching, since the mixed acid does not etch silicon dioxide of the first insulation layer 103 as shown in FIG. 5B, the etching automatically stops at the first insulation layer 103.

Then, after the etching described above, a second adhesive layer 126 was formed on the rear face side of the thin film device layer 121, that is, on the surface of the insulation layer 103 as shown in FIG. 5C. For example, an ultraviolet curing type bonding agent was used for the second adhesive layer 126.

Then, a third substrate 127 was pasted to the second adhesive layer 126. A fiber cloth 128 is included in the third substrate 127, and, for example, a glass cloth-containing plastic substrate was used for the third substrate 127. The plastic substrate mentioned is formed from epoxy resin which contains a glass cloth whose main component is silicon dioxide. The glass cloth is formed in the following manner. For example, several to several tens thin glass wires of a diameter of approximately 1 μm to 20 μm are bundled into a single yarn of a diameter of 10 μm to 300 μm. In the present production, a yarn of a diameter of approximately 100 μm was used. The yarn is used for plain weaving. Since the glass cloth is plain weaved, warp yarns and weft yarns cross perpendicularly with each other. Consequently, the linear expansion coefficient of the substrate is equal in the longitudinal direction and the transverse direction in the plane of the substrate. The linear expansion coefficient of the substrate used in the present production is 13 ppm/K. Where the thermal expansion coefficient difference from an inorganic thin film layer is taken into consideration, the linear expansion coefficient of the substrate should be 30 ppm or less, preferably 15 ppm or less. The thickness of the substrate preferably is 10 μm to 500 μm, and the thickness of the substrate in the present production is 200 μm. Thereafter, ultraviolet rays were irradiated to harden the second adhesive layer 126.

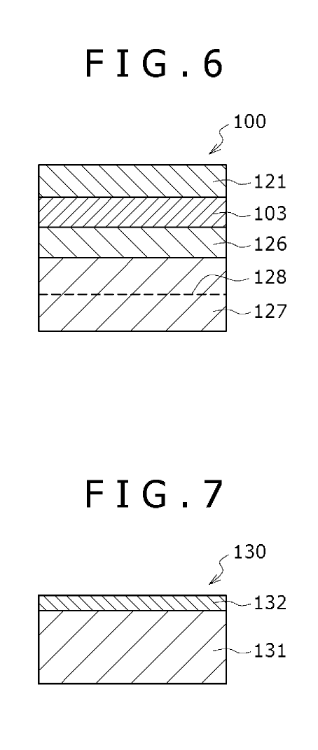

Then, the substrate was immersed in alcohol (not shown) to dissolve the first adhesive layer 123 (refer to FIG. 4A) formed from a hot melt bonding agent to remove the second substrate 124 (refer to FIG. 4A). As a result, a thin film device (active substrate) 100 wherein the thin film device layer 121 was placed on the third substrate 127, which contained the fiber cloth 128, with the second adhesive layer 126 and the insulation layer 103 interposed therebetween as shown in FIG. 6 (6) was obtained.

Now, an example of fabrication of an opposing substrate is described with reference to a schematic configuration sectional view of FIG. 7.

As shown in FIG. 7, an opposing substrate 130 was produced such that a plastic substrate 131 was prepared and a transparent electrode 132 was formed on the overall face of the plastic substrate 131 side. The transparent electrode 132 was formed using, for example, ITO (Indium Tin Oxide). The ITO film was formed, for example, by a sputtering method.

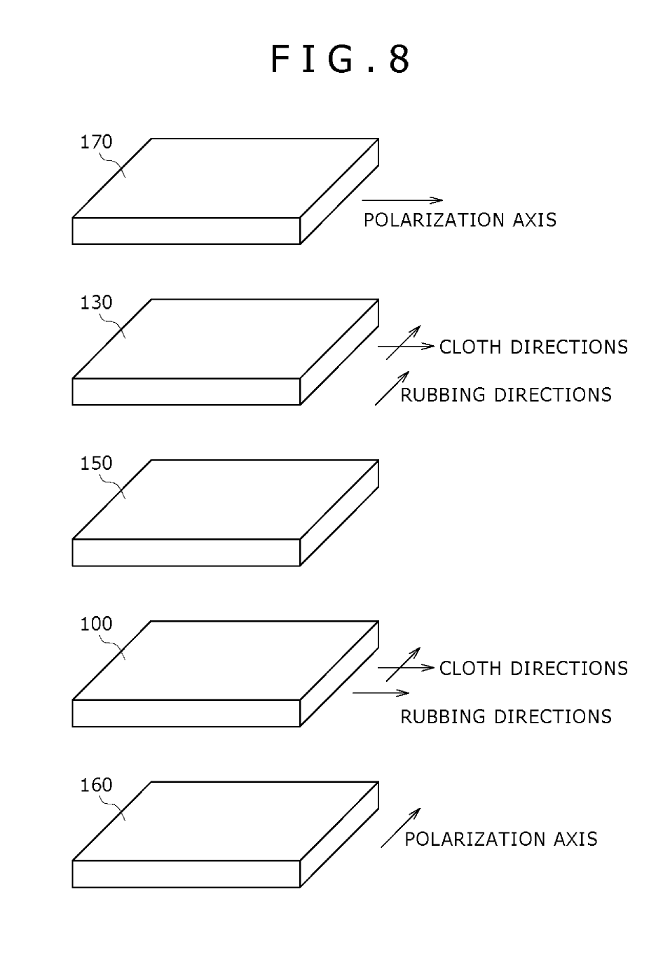

Thereafter, as shown in FIG. 8, though not shown, an orientation process of coating an orientation film (for example, a polyimide film) to the opposing substrate 130 and the active substrate 100 and performing a rubbing process was performed. The rubbing direction was such that rubbing was performed in one direction of the glass fiber contained in the active substrate 100 and the rubbing directions of the opposing substrate 130 and the active substrate 100 were perpendicular to each other.

Then, sealant (not shown) was coated to the active substrate 100, and a large number of spacers (not shown) were coated to the opposing substrate 130.

Then, the active substrate 100 and the opposing substrate 130 were pasted to each other, and ultraviolet rays were irradiated while a pressure of, for example, 1 kg/cm² was applied to harden the sealant. Then, the active substrate 100 and the opposing substrate 130 were cut into a size of a panel by laser working, and liquid crystal 150 was poured into the cut piece from an inlet (not shown). Then, the inlet was covered with molding resin and the molding resin was hardened to produce a liquid crystal display panel. In this production, TN liquid crystal was used as the liquid crystal.

A first polarizing plate 160 was pasted to the opposite sides of the liquid crystal display panel, that is, on the outer sides of the active substrate 100 and a second polarizing plate 170 was pasted to the outer sides of the opposing substrate 130 to produce a liquid crystal display apparatus. The first and second polarizing plates 160 and 170 were pasted together such that the polarizing axes thereof extended perpendicularly (orthogonally) to each other similarly as in the description given hereinabove with reference to FIG. 2. While, in the production, a normally white mode was used, where a normally black mode is to be used, such alteration as to dispose two polarizing plates so as to be perpendicular to each other or perform rubbing such that the rubbing directions of the active substrate and the opposing substrate are parallel to each other. It is to be noted that, if the axis of the polarizing plate and the rubbing direction are adjusted to the cloth axis, then the cloth axis may be directed in any direction with respect to the substrate, and in this instance, the angular field of view and so forth are sometimes improved.

Since the liquid crystal display apparatus produced by the steps described above does not suffer from cracking or the like even if the temperature is raised because the linear expansion coefficient of the substrate is low. Further, in the case of the plastic substrate in which a glass cloth is contained, since the fiber direction of the glass fiber and the direction of the optical axis of the polarizing plates are same as each other, also a portion in which the fiber overlaps exhibits same display as that at another portion in which the fiber does not overlap.

The present invention relies upon the fact that, based on a result of an analysis of an overlapping portion of glass fiber found out by the inventor of the present invention, that is, based on a discovery that the stress applied to a resin portion of a plastic substrate acts along the direction of the glass fiber, the optical axis of double refraction coincides with the direction of the glass fiber without fail. The present invention was made based on this knowledge, and in the liquid crystal display apparatus and the fabrication method therefor of the first example of the present invention, in at least one of the pair of substrates, the third substrate 127 made of resin and containing the fiber cloth 128 is used as the active substrate 100, and the first and second polarizing plates 160 and 170 are provided on the outer sides of the active substrate 100 and the opposing substrate 130, respectively. Further, the axis of the fiber and the optical axis of the polarizing plates are coaxial, and therefore, the optical axis of the double refraction and the axis of the first polarizing plate 160 can be made coaxial. Consequently, there is an advantage that the influence of the double refraction is eliminated and, at a portion at which the glass fiber overlaps, normal display same as that at any other portion can be obtained. Therefore, a plastic substrate which contains a less expensive glass cloth can be used, and the fabrication cost of the liquid crystal display apparatus decreases.

### EXAMPLE 2

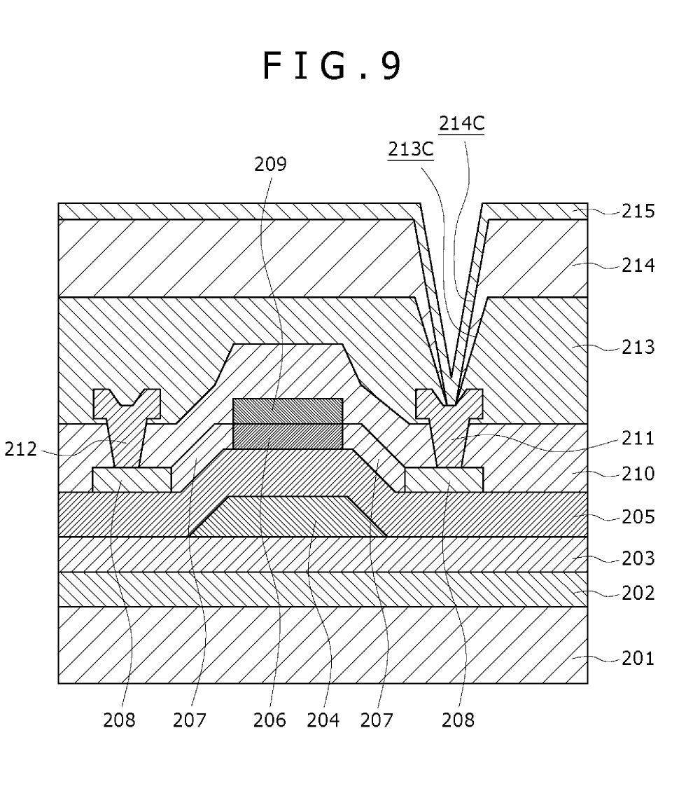

A second example of the liquid crystal display apparatus and the fabrication method for a liquid crystal display apparatus of the present invention is described with reference to sectional views of FIGS. 9 to 11. In the second example, an active substrate for reflection type liquid crystal was produced on a plastic substrate.

First, a forming method of a thin film device layer is described with reference to FIG. 9. As shown in FIG. 9, an amorphous silicon layer 202 is formed on a first substrate 201. For the first substrate 201, a glass substrate, for example, of a thickness of approximately 0.4 mm to 1.1 mm, for example, of a thickness of 0.7 mm is used. A quartz substrate may be used in place of the glass substrate. Further, the film thickness of the amorphous silicon layer 202 was, for example, 50 nm. There is no problem if the film thickness ranges from 10 nm to 1 μm. A plasma CVD method was used as the film forming method of the amorphous silicon layer 202. In the plasma CVD method, preferably the temperature is set as low as possible unless a thin film device layer does not peel off midway of the fabrication so that much hydrogen may be contained in the amorphous silicon layer 202. In the production, the film formation was performed at 150° C. Further, there is no problem even if the amorphous silicon layer 202 is formed by a low pressure CVD method, an atmospheric pressure plasma CVD method, an ECR method or a sputtering method.

Then, a protective insulation layer 203 is formed on the amorphous silicon layer 202. The protective insulation layer 203 was formed so as to have a thickness of, for example, 100 nm. The protective insulation layer 203 can be formed, for example, by a plasma CVD method.

Thereafter, a popular low temperature poly-silicon technique, for example, such a low temperature poly-silicon bottom gate type thin film transistor (a thin film transistor is hereinafter referred to as TFT) process as disclosed, for example, in “2003 FPD technology complete collection” (Electronic Journal, issued Mar. 25, 2003, pp. 166 to 183 and pp. 198 to 201), “'99 latest liquid crystal process technique” (Press Journal, issued 1998, pp. 53 to 59), “Flat panel display 1999” (Nikkei BP Company, issued 1998, pp. 132 to 139) and so forth, was used to form a thin film device layer including a TFT. An example of the forming method of a thin film device layer is described below.

First, a conductive film for forming a gate electrode 204 was formed on the protective insulation layer 203 formed on the first substrate 201 with the amorphous silicon layer 202 interposed therebetween. For the conductive film, a molybdenum (Mo) film of a thickness of, for example, 100 nm was used. For example, a sputtering method was used as the forming method of the molybdenum film. Then, the conductive film was formed into a gate electrode 204. The gate electrode 204 was formed by patterning using a popular photolithography technique and etching technique. Then, a gate insulation film 205 was formed on the gate electrode 204 in such a manner as to coat the gate electrode 204. The gate insulation film 205 was formed as a silicon dioxide (SiO₂) layer or as a laminate of a silicon dioxide (SiO₂) layer and a silicon nitride (SiNₓ), for example, by a plasma CVD method. Further, an amorphous silicon layer (thickness of 30 nm to 100 nm) was formed continuously.

XeCl excimer laser pulses of a wavelength of 308 nm were irradiated upon the amorphous silicon layer to melt and recrystallize the amorphous silicon layer to produce a crystal silicon layer (poly-silicon layer). The poly-silicon layer was used to form a poly-silicon layer 206 from which a channel formation region is to be formed, and a poly-silicon layer 207 formed from an n− type doped region and another poly-silicon layer 208 formed from an n+ type doped region were formed on the opposite sides of the poly-silicon layer 206. In this manner, the active region was formed with an LDD (Lightly Doped Drain) structure for achieving both of high on-current and low off-current. Further, a stopper layer 209 for protecting a channel upon implantation of n− type phosphorus ions. The stopper layer 209 was formed, for example, as a silicon dioxide (SiO₂) layer.

Furthermore, a passivation film 210 formed from a silicon dioxide (SiO₂) layer or a laminate of a silicon dioxide (SiO₂) layer and a silicon nitride (SiNₓ) was formed by a plasma CVD method. A source electrode 211 and a drain electrode 212 connecting individually to the poly-silicon layer 208 were formed on the passivation film 210. The source electrode 211 and the drain electrode 212 were formed from a conductive material such as, for example, aluminum, aluminum alloy or high melting point metal.

After the source electrode 211 and the drain electrode 212 were formed, a protective layer 213 was formed in order to protect the devices and perform flattening. The protective layer 213 is formed from a material, for example, of a polymethyl methacrylate resin type. Then, the protective layer 213 is formed so as to have an uneven surface so that convexes and concaves are formed on the surface of a reflecting layer to be formed on the protective layer 213 at the next step. Then, a contact hole 213C was formed in the protective layer 213 by an ordinary contact hole forming technique so that the source electrode 211 and a liquid crystal driving electrode to be formed later might be connected to each other. Thereafter, a reflecting layer 214 is formed on the surface of the protective layer 213 and the inner face of the contact hole 213C. This reflecting layer 214 was formed by deposition of silver (Ag), for example, by sputtering.

After the formation of the reflecting layer 214, a color filter 215 was formed. This was formed by coating color resist to the overall face and the performing patterning by a lithography technique. Then, a contact hole 215C was formed in the color filter 215 so that the source electrode 211 and a liquid crystal driving electrode to be formed later might be connected to each other. The color filter forming step was performed three times to form color filters for the three colors of RGB (red, green, blue).

Thereafter, a pixel electrode 216 was formed on the surface of the color filter 215 and the inner face of the contact hole 215C. The pixel electrode 216 was formed by deposition of, for example, indium tin oxide (ITO), for example, by sputtering. Accordingly, the pixel electrode 216 is formed in a connected relationship to the source electrode 211.

Through the steps described above, an active matrix substrate was successfully formed on the first substrate 201 formed from a glass substrate. Further, although, in the production described, a bottom gate type poly-silicon TFT was produced, the present invention can be carried out similarly also with a top gate type poly-silicon TFT or an amorphous TFT.

Now, a process of transferring a thin film device layer on the first substrate 201 to a plastic substrate is described.

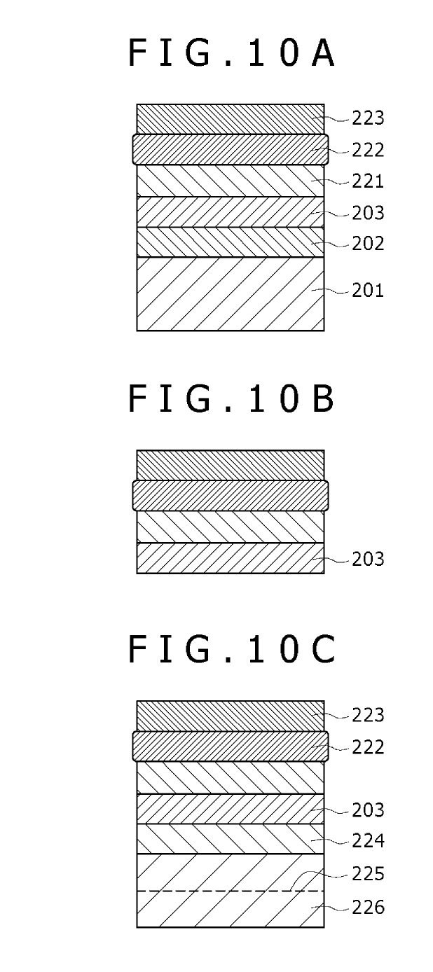

As shown in FIG. 10A, to a thin film device layer 221 formed on a first substrate 201 with an amorphous silicon layer 202 and a protective insulation layer 203 interposed therebetween, a second substrate 223 is adhered with a first adhesive layer 222 interposed therebetween. For the second substrate 223, for example, a molybdenum substrate of a thickness of 1 mm was used. Alternatively, a glass substrate may be used for the second substrate 223. Further alternatively, the first adhesive layer 222 may be formed on the second substrate 223 and the thin film device layer 221 side portion of the first substrate 201 having the layers from the amorphous silicon layer 202 to the thin film device layer 221 formed thereon may be placed on the first adhesive layer 222. For example, a hot melt bonding agent was used for the first adhesive layer 222.

Then, xenon chloride (XeCl) excimer layer light was irradiated from the first substrate 201 side formed from a glass substrate. Since glass transmits the excimer laser light therethrough, the laser light is absorbed by the amorphous silicon layer 202. When ultraviolet rays are absorbed by the amorphous silicon layer 202, hydrogen is generated, and separation of the thin film device layer 221 and the first substrate 201 from each other occurs across the amorphous silicon layer 202. Details of this technique are disclosed in Japanese Patent Laid-open No. Hei 10-125930. As a result, the protective insulation layer 203 was exposed as shown in FIG. 10B.

Then, a second adhesive layer 224 was formed on the protective insulation layer 203 as shown in FIG. 10C. This second adhesive layer 224 is formed by coating of, for example, an ultraviolet curing bonding agent. For the coating method, spray coating, dip coating or spin coating can be used.

Thereafter, a third substrate 225 was pasted to the second adhesive layer 224. The third substrate 225 contains a fiber cloth 226, and, for example, for the third substrate 225, a glass cloth-containing plastic substrate was used. The plastic substrate is formed from epoxy resin which contains a glass cloth whose principal component is silicon dioxide. The glass cloth is formed in the following manner. For example, several to several tens thin glass wires of a diameter of approximately 1 μm to 20 μm are bundled into a single yarn of a diameter of 10 μm to 300 μm. In the present production, a yarn of a diameter of approximately 100 μm was used. The yarn is used for plain weaving. Since the glass cloth is plain weaved, warp yarns and weft yarns cross perpendicularly to each other. Consequently, the linear expansion coefficient of the substrate is equal in the longitudinal direction and the transverse direction in the plane of the substrate. The linear expansion coefficient of the substrate used in the present production is 13 ppm/K. Where the thermal expansion coefficient difference from an inorganic thin film layer is taken into consideration, the linear expansion coefficient of the substrate should be 30 ppm or less, preferably 15 ppm or less. The thickness of the substrate preferably is 10 μm to 500 μm, and the thickness of the substrate in the presence case is 200 μm. Thereafter, ultraviolet rays were irradiated to harden the second adhesive layer 224.

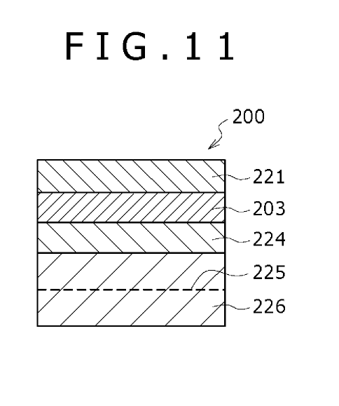

Then, the substrate was immersed in alcohol to dissolve the first adhesive layer 222 formed from a hot melt bonding agent to remove the second substrate 223. As a result, a thin film device (active substrate) 200 wherein the thin film device layer 221 was exposed and the thin film device layer 221 was placed on the third substrate 225 with the second adhesive layer 224 and the protective insulation layer 203 interposed therebetween as shown in FIG. 11 (4) was obtained.

Then, though not shown, an orientation process of coating an orientation film (for example, a polyimide film) to the opposing substrate 130 and the active substrate 200 and then performing a rubbing process was performed in a similar manner as described hereinabove with reference to FIG. 8. The rubbing direction was such that rubbing was performed in the direction of the glass fiber contained in the active substrate 200 and the rubbing directions of the opposing substrate 130 and the active substrate 200 were perpendicular to each other.

Then, sealant (not shown) was coated to the active substrate 200, and a large number of spacers were sprayed to the opposing substrate 130.

Then, the active substrate 200 and the opposing substrate 130 were pasted to each other, and ultraviolet rays were irradiated while a pressure of, for example, 1 kg/cm² was applied to harden the sealant. Then, the active substrate 200 and the opposing substrate 130 were cut into a size of a panel by laser working, and liquid crystal 150 was poured into the cut piece from an inlet. Then, the inlet was covered with molding resin and the molding resin was hardened to produce a liquid crystal display panel. In this production, TN liquid crystal was used as the liquid crystal.

In the second example described above, similarly as in the first example described hereinabove, the third substrate 225 made of resin and containing the fiber cloth 226 is used as the active substrate 200 as at least one of a pair of substrates, and the first and second polarizing plates 160 and 170 are provided on the outer sides of the active substrate 200 and the opposing substrate 130, respectively. Further, the axis of the fiber and the optical axis of the polarizing plates are coaxial, and therefore, the optical axis of the double refraction and the axis of the first polarizing plate 160 can be made coaxial. Consequently, there is an advantage that the influence of the double refraction is eliminated and, at a portion at which the glass fiber overlaps, normal display same as that at any other portion can be obtained. Therefore, a plastic substrate which contains a less expensive glass cloth can be used, and the fabrication cost of the liquid crystal display apparatus decreases.

### EXAMPLE 3

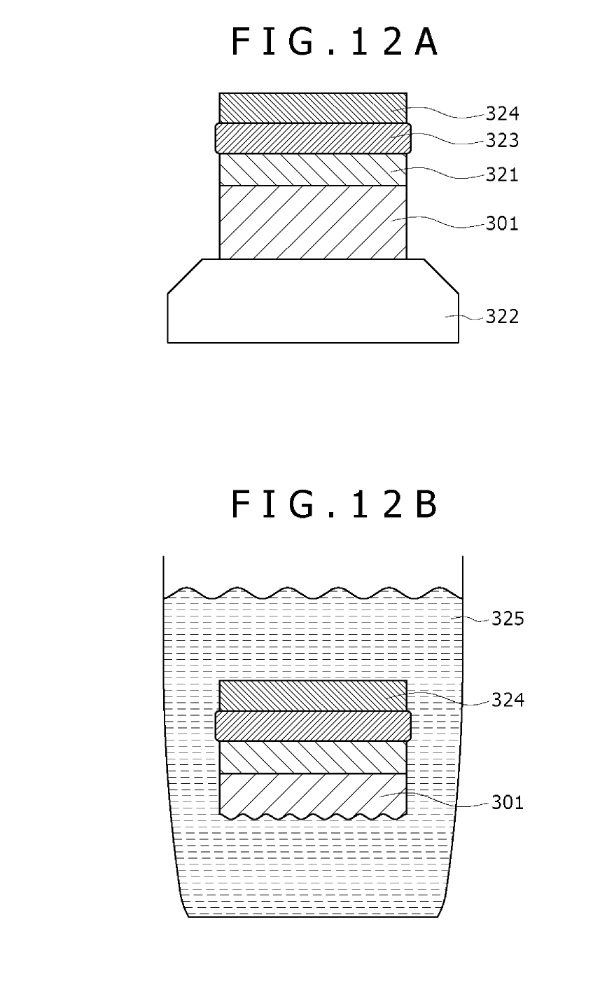

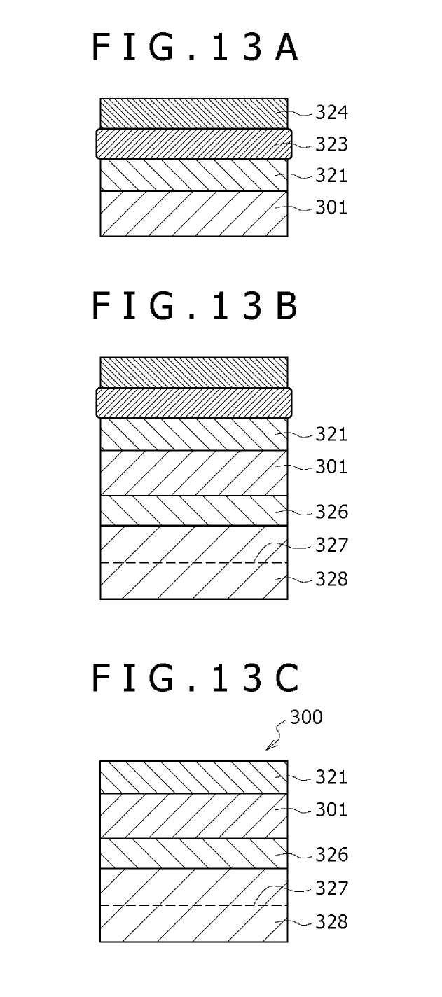

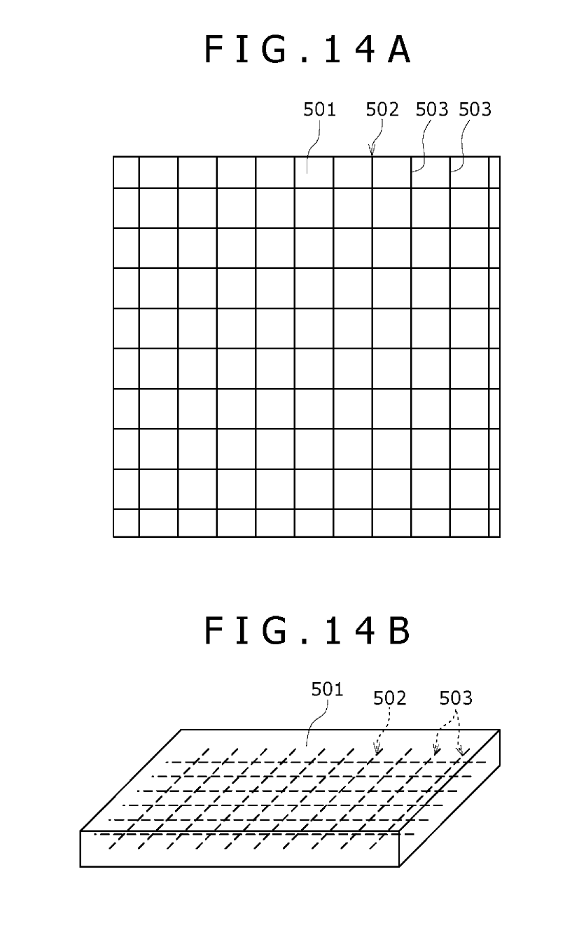

A third example of the liquid crystal display apparatus and the fabrication method for a liquid crystal display apparatus of the present invention is described with reference to sectional views of FIGS. 12 to 13. In the third example, a thin film device layer was transferred to a resin substrate which contained a glass cloth in a state wherein part of a first substrate (glass substrate) on which the thin film device layer was formed was left to form an active substrate.

First, a thin film device layer is formed by a fabrication method similar to that in the first example described hereinabove with reference to FIG. 3.

Then, as shown in FIG. 12A, while a block wherein the thin film device layer 321 was formed on a first substrate 301 was heated to 80° C. to 140° C. by a hot plate 322, for example, a hot melt bonding agent was coated to a thickness of, for example, approximately 1 mm to form a first adhesive layer 323. Then, a second substrate 324 was placed on the first adhesive layer 323, and while the second substrate 324 was pressurized toward the first substrate 301, it was cooled to a room temperature. For example, a molybdenum (Mo) substrate of a thickness of, for example, 1 mm was used for the second substrate 324. Alternatively, a hot melt bonding agent may be coated to the second substrate 324 and the thin film device layer 321 side portion of the first substrate 301 having the thin film device layer 321 formed thereon may be placed on the hot melt bonding agent.

Then, the substrate to which the second substrate 324 was pasted was immersed in hydrofluoric acid 325 as shown in FIG. 12B to perform etching of the first substrate 301. In this etching, the etching end point is controlled, for example, with the etching time period so that a thickness of, for example, approximately 30 μm may remain with the first substrate 301. As an example, the hydrofluoric acid 325 used here has a weight concentration of 15% to 25%, and the etching time period was approximately three hours at a room temperature while the hydrofluoric acid solution was agitated by bubbling by an air blow. There is no problem even if the concentration and the etching time of the hydrofluoric acid 325 are changed suitably. The first substrate 301 may be made thinner by polishing such as, for example, mechanical polishing or chemical-mechanical polishing in place of the etching described above.

As a result of the etching with the hydrofluoric acid 325 described above, an article is obtained wherein the thin film device layer 321 is formed on the first substrate 301 and the second substrate 324 is formed on the thin film device layer 321 with the first adhesive layer 323 interposed therebetween as seen in FIG. 13A.

Thereafter, a second adhesive layer 326 is formed on a face of the first substrate 301 opposite to the face on which the thin film device layer 321 is formed as shown in FIG. 13B. The second adhesive layer 326 was formed, as an example, by coating ultraviolet curing bonding agent of an acrylic type, for example, by a rotary coating technique. In the film formation by the rotary coating technique, the film thickness was approximately 10 μm.

Then, a third substrate (plastic substrate) 327 was pasted to the second adhesive layer 326. A fiber cloth 328 is contained in the third substrate (plastic substrate) 327, and for example, a glass cloth-containing plastic substrate was used for the third substrate 327. The plastic substrate is formed from epoxy resin which contains silicon dioxide as a main component. The glass substrate is formed in the following manner. For example, several to several tens thin glass wires of a diameter of approximately 1 μm to 20 μm are bundled into a single yarn of a diameter of 10 μm to 300 μm. In the present production, a yarn of a diameter of approximately 100 μm was used. The yarn is used for plain weaving. Since the glass cloth is plain weaved, warp yarns and weft yarns cross perpendicularly with each other. Consequently, the linear expansion coefficient of the substrate is equal in the longitudinal direction and the transverse direction in the plane of the substrate. The linear expansion coefficient of the substrate used in the present production is 13 ppm/K. Where the thermal expansion coefficient difference from an inorganic thin film layer is taken into consideration, the linear expansion coefficient of the substrate should be 30 ppm or less, preferably 15 ppm or less. The thickness of the substrate preferably is 10 μm to 500 μm, and the thickness of the substrate in the present production is 200 μm. Thereafter, ultraviolet rays were irradiated to harden the second adhesive layer 326.

Then, the substrate was immersed in alcohol (not shown) to dissolve the first adhesive layer 323 (refer to FIG. 12A) formed from a hot melt bonding agent to remove the second substrate 323 (refer to FIG. 12A). As a result, a thin film device (active substrate) 300 was obtained wherein the thin film device layer 321 was placed on the third substrate 327, which contained the fiber cloth 328, with the second adhesive layer 326 and the first substrate 301 interposed therebetween as shown in FIG. 13C.

The steps after then are similar to those in the first example described hereinabove.

In particular, though not shown, an orientation process of coating an orientation film (for example, a polyimide film) to the opposing substrate 130 and the active substrate 300 and then performing a rubbing process was performed in a similar manner as described hereinabove with reference to FIG. 8. The rubbing direction was such that rubbing was performed in the direction of the glass fiber contained in the active substrate 300 and the rubbing directions of the opposing substrate 130 and the active substrate 300 were perpendicular to each other.

Then, sealant (not shown) was coated to the active substrate 300, and a large number of spacers were coated to the opposing substrate 130.

Then, the active substrate 300 and the opposing substrate 130 were pasted to each other, and ultraviolet rays were irradiated while a pressure of, for example, 1 kg/cm² was applied to harden the sealant. Then, the active substrate 300 and the opposing substrate 130 were cut into a size of a panel by laser working, and liquid crystal 150 was poured into the cut piece from an inlet (not shown). Then, the inlet was covered with molding resin and the molding resin was hardened to produce a liquid crystal display panel. In this production, TN liquid crystal was used as the liquid crystal.

In the third example described above, similarly as in the first example described hereinabove, the third substrate 327 made of resin and containing the fiber cloth 328 is used as the active substrate 300 as at least one of a pair of substrates, and the first and second polarizing plates 160 and 170 are provided on the outer sides of the active substrate 300 and the opposing substrate 130, respectively. Further, the axis of the fiber and the optical axis of the polarizing plates are coaxial, and therefore, the optical axis of the double refraction and the axis of the first polarizing plate 160 can be made coaxial. Consequently, there is an advantage that the influence of the double refraction is eliminated and, at a portion at which the glass fiber overlaps, normal display same as that at any other portion can be obtained. Therefore, a plastic substrate which contains a less expensive glass cloth can be used, and the fabrication cost of the liquid crystal display apparatus decreases.

### EXAMPLE 4

A fourth example of the liquid crystal display apparatus and the fabrication method for a liquid crystal display apparatus of the present invention is described below. In the fourth example, a thin film device wherein a thin film device layer is provided on a first substrate is formed by a fabrication method similar to that in the first example. In the present fourth example, the thin film device formed on the first substrate is used as an active substrate. Accordingly, the active substrate is formed from a thin film device layer on a glass substrate. Meanwhile, for an opposing substrate, the opposing substrate of the first example described hereinabove with reference to FIG. 7 is used.

The active substrate and the opposing substrate are pasted to each other with spacers interposed therebetween, and liquid crystal is encapsulated in a space between the active substrate and the opposing substrate. After this step, similar steps to those in the first example are performed.

Also with the fourth example described above, similar operation and effects to those of the first example are achieved.

### INDUSTRIAL APPLICABILITY

The liquid crystal display apparatus and the fabrication method for a liquid crystal display apparatus of the present invention are preferably applied to a liquid crystal display apparatus for which a plastic substrate is used and a fabrication method for the liquid crystal display apparatus.

The inventor of the present invention found out that, as a result of an analysis performed with regard to an overlapping portion of glass fiber, the stress applied to a resin portion of a plastic substrate acts along the direction of the glass fiber, and found out based on the fact that the optical axis of double refraction coincides with the direction of the glass fiber without fail. The present invention was made based on this knowledge. In particular, in the liquid crystal display apparatus and the fabrication method therefor of the present invention, a resin substrate containing a fiber cloth is used as at least one of a pair of substrates, and a polarizing plate is provided on the outer side of at least one of the paired substrates. Further, the axis of the fiber and the optical axis of the polarizing plate are coaxial, and therefore, the optical axis of the double refraction and the axis of the polarizing plate can be made coaxial. Consequently, there is an advantage that the influence of the double refraction is eliminated and, at a portion at which the glass fiber overlaps, normal display same as that at any other portion can be obtained. Therefore, a plastic substrate which contains a less expensive glass cloth can be used, and the fabrication cost of the liquid crystal display apparatus decreases. It is to be noted that the term coaxial here signifies that the optical axis of the polarizing plate and at least one of axes of the fiber extend in parallel to each other.

1. A liquid crystal display apparatus wherein a liquid crystal driving electrode is formed on at least one of a pair of substrates opposing to each other and liquid crystal is encapsulated in a space formed with a distance between said substrates which is kept by a spacer provided between said substrates, characterized in that:
at least one of said pair of substrates is a resin substrate which contains a fiber cloth; that
a polarizing plate is provided on the outer side of at least one of said pair of substrates; and that an axis of the fiber and an optical axis of said polarizing plate are coaxial with each other.

2. The liquid crystal display apparatus as set forth in claim 1, characterized in that
said fiber cloth of the resin substrate has a check-pattern plain-weaved structure, and that
said resin substrate has, in a main face thereof, a region in which only the resin which forms said resin substrate exists and another region in which the resin and said fiber cloth exist, as viewed in a thicknesswise direction of the resin substrate.

3. The liquid crystal display apparatus as set forth in claim 1, characterized in that said liquid crystal driving electrode is formed from an electrode which is first formed on a substrate for fabrication and then transferred to the resin substrate which contains said fiber cloth.

4. The liquid crystal display apparatus as set forth in claim 1, characterized in that said fiber cloth is a glass cloth formed from glass fiber.

5. A fabrication method for a liquid crystal display apparatus wherein a liquid crystal driving electrode is formed on at least one of a pair of substrates opposing to each other and liquid crystal is encapsulated in a space formed with a distance between said substrates which is kept by a spacer provided between said substrates, characterized in that:
a resin substrate which contains a fiber cloth for at least one of said pair of substrates; that
a polarizing plate is disposed on the outer side of at least one of said pair of substrates; and that
an axis of said fiber and an optical axis of said polarizing plate are made coaxial with each other.

6. The fabrication method for the liquid crystal display apparatus as set forth in claim 5, characterized in that
a fiber cloth which has a check-pattern plain-weaved structure is used as said fiber cloth of the resin substrate, and that
said resin substrate has, in a main face thereof, a region in which only the resin which forms said resin substrate exists and another region in which the resin and said fiber cloth exist, as viewed in a thicknesswise direction of the resin substrate.

7. The fabrication method for the liquid crystal display apparatus as set forth in claim 5, characterized in that said liquid crystal driving electrode is formed from an electrode which is first formed on a substrate for fabrication and then transferred to the resin substrate which contains said fiber cloth.

8. The fabrication method for the liquid crystal display apparatus as set forth in claim 5, characterized in that a glass cloth formed from glass fiber is used for said fiber cloth.
